(19) United States
(12) Patent Application Publication
(10) Pub. No.: US 2008/0152921 A1
(43) Pub. Date: Jun. 26, 2008

(54) Thermally B-Stageable Composition for Rapid Electronic Device Assembly

(75) Inventor: Michael A. Kropp, Cottage Grove, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/613,315

(22) Filed: Dec. 20, 2006

(51) Int. Cl. B32B 27/38; C08L 71/00; C09J 163/00

(52) U.S. Cl. 428/414; 525/403; 156/330

(57) ABSTRACT

Provided is an adhesive composition useful for electronic assembly comprising a curable epoxy resin, a plurality of polymer particles having at least one of a plurality of acid functional groups or a composition which swells in the presence of the epoxy resin at a first temperature and a thermally activated cure agent and/or a thermally activated cure catalyst which becomes active at a second, temperature, wherein the second temperature is higher than the first temperature. Also provided are assemblies including such adhesives and methods of assembling same.

### TECHNICAL FIELD

This invention relates generally to a B-stageable and thermally curable composition and, in particular, to a composition that B-stages at a first low temperature and cures to a structural adhesive at higher temperatures. The composition is useful, for example, for attaching semiconductor dice to carriers and for attaching covers to semiconductor packages.

### BACKGROUND

There is an increasing desire in the electronics industry to reduce manufacturing costs in electronics assembly operations. This especially is true in certain high volume assembly applications such as attaching semiconductor dice to carriers and attaching covers to semiconductor packages. One method, which can reduce costs in certain applications, is the use of adhesives to connect components together. However, known materials are inefficient and expensive due to such problems as “slumping” where adhesive flows beyond the target application site, excessive waste from die cut films, and reduced throughput with other materials due to multiple in-line curing steps.

### SUMMARY

The present disclosure provides an adhesive composition for electronic assembly comprising a curable epoxy resin, a plurality of polymeric particles having at least one of a plurality of acid or acid anhydride functional groups on its surface, or a surface which swells in the presence of the curable epoxy resin at or above a first temperature, and at least one of a thermally activated cure agent for curable epoxy resins or a thermally activated cure catalyst for curable epoxy resins which becomes active at a second temperature, wherein the second temperature is higher than the first temperature.

In another aspect, the present disclosure provides an adhesive composition for electronic assembly including a reaction product of a resin, containing polymerizable epoxy groups, that is curable with a plurality of polymer particles, preferably having acid or acid anhydride functionality on the surface of the particles, and a thermally activated epoxy cure agent or an epoxy cure catalyst. For the purposed of this application, the term “curable” includes viscosity increases resulting from either or both of a thermally induced chemical reaction and swelling of one or more components of a mixture by another component of the mixture upon heating above ambient temperature.

In another aspect, the present disclosure provides a method of assembling components using a printable, thermally B-staged, further thermally curable epoxy-based adhesive. In some embodiments, the thermal B-stage is accomplished by mild heating to promote an interaction, reactive or by swelling, between an epoxy resin and a plurality of polymeric particles such that the viscosity increases sufficiently to prevent slumping. The thermal B-stage is followed by a thermal cure at a higher temperature.

In some embodiments, the compositions of the present disclosure are useful for rapid electronic assembly, such as attaching semiconductor dice to carriers and attaching covers to semiconductor packages. The compositions of the present disclosure are particularly useful in assembly operations in which the adhesive desirably is colored or even opaque to a degree which would be difficult to attain in a system which is B-staged photochemically, for example by UV radiation, where the materials to be joined are opaque, or in which the required adhesive thickness is too great for easy photochemical curing.

In some embodiments, the disclosure relates to an adhesive composition for electronic assembly comprising a curable epoxy resin, a plurality of polymeric particles having at least one of a plurality of acid or acid anhydride functional groups on its surface, or a surface which swells in the presence of the curable epoxy resin, at or above a first, temperature, and at least one of a thermally activated cure agent for curable epoxy resins or a thermally activated cure catalyst for curable epoxy resins which becomes active at a second temperature higher than the first temperature. In some embodiments, the disclosure provides an assembly comprising a first substrate, which may comprise an electronic circuit or device, a second substrate, which may comprise an electronic circuit or device; and an adhesive composition adhering the first and second substrates optionally wherein, when the first and second substrates are electronic circuits and the adhesive contains conductive particles, the adhesive electrically interconnects the circuits. In some embodiments, the adhesive composition is applied to a first substrate, heated to a first temperature before application of the second substrate and subsequently heated to a second, higher temperature to complete the cure of the adhesive.

In some embodiments, the disclosure relates to a method of assembly comprising providing a substrate and an adherent, applying the adhesive composition to one of said substrate and said adherent, heating said applied adhesive composition to a first temperature, cooling the adhesive composition, applying the adherent to the previously heated adhesive composition, and heating the adhesive composition to a second, higher temperature to further advance the cure of the adhesive composition. In other embodiments, the cooling step may be omitted.

The present inventor discerned a need for an adhesive composition which can be B-staged quickly and efficiently and which allows for quick assembly of electronic components, such as die attach or lid attach operations in semiconductor device assembly operations.

Other features and advantages of the invention will be apparent from the following detailed description of the invention and the claims. The above summary of principles of the invention disclosure is not intended to describe each illustrated embodiment or every implementation of the present disclosure. The figures and the detailed description that follow more particularly exemplify certain preferred embodiments using the principles disclosed herein.

### DETAILED DESCRIPTION

All numbers herein are assumed to be modified by the term “about”. The recitation of numerical ranges by endpoints includes all numbers subsumed within that range (e.g., 1 to 5 includes 1, 1.5, 2, 2.75, 3, 3.80, 4, and 5).

Adhesive resins can be applied by in-line sequential dispensing, adhesive printing, or using film adhesives. However, in-line dispensing is inefficient and expensive, for example because it takes time to index the dispensing head to the multiple bond locations. Moreover, to facilitate dispensing from the head, many resins must include solvents to reduce resin viscosity to a dispensable range. This lowered viscosity allows the resin to flow beyond the original application site, also known as “slumping”. In addition to contributing to slumping, the inclusion of solvents may impose limitations on the area which can be effectively adhered with out trapping residual solvent. Such trapped solvent may introduce voids or otherwise weaken the eventual bond. Another useful method of applying adhesive is screen or stencil printing, where adhesive is applied through a stencil so that the adhesive is applied in the desired position or positions. Screen printing allows simultaneous application to multiple bond sites, so it is less expensive and more conducive to high-volume manufacturing than is in-line dispensing. Screen printing can also provide good wetting of bond sites because the composition is still a liquid when it is printed. However slumping problems may still exist with these techniques. Ideally, the composition should able to be applied by screen, stencil, roll printing and the like, be quickly B-stageable to avoid slumping and other problems, and be curable offline, to maximize efficiency during manufacturing.

One way to reduce slumping is by thickening the resin after dispensing to avoid slumping, or “B-staging” the adhesive resin. Both thermal B-staging, where solvent is removed by exposure to a specified thermal regime, and ultraviolet (UV) B-staging, where UV or another light source initiates a curing reaction to thicken the composition prior to contact and final curing, have been used. However, known thermal B-staging is inefficient because it takes time, which increases manufacturing costs and may lead to undesired slumping as well as introducing voids and UV B-staging has not been practical for many electrical assembly applications, i.e., assembly of semiconductor dice to carriers and attaching covers to semiconductor packages. In some embodiments, the present invention provides an adhesive composition comprising a mixture of thermally curable epoxy resins and polymer particles which is free of undesirable solvents. In some embodiments, the present invention advantageously uses a relatively fast but limited thermal cure to create a composition that rapidly B-stages after heating to an intermediate temperature to minimize slumping problems followed by more complete curing at a higher temperature, allowing the electronic component to be assembled before the composition is substantially fully cured. In some embodiments, the present invention provides for fast assembly of electronic components, such as attaching semiconductor dice to carriers and attaching covers to semiconductor packages, thereby increasing overall production efficiency.

In some embodiments, the composition of the present invention disclosure can be printed onto an adherent or a substrate in a predetermined pattern. Then, the composition is heated to an intermediate temperature. In some embodiments, it is believed that this initial heating primarily promotes the reaction between the resin and the acid functional groups on the surface of the polymeric particles yet without significantly activating the thermal catalyst and that a limited number of available acid functional surface groups on the polymer particles limits the degree of cure of the overall system to that necessary to prevent slumping. In some embodiments, reaction between the epoxy resin and the acid groups on the surfaces of the polymeric particles increases the viscosity of the composition to B-stage the composition so that it will remain in the predetermined pattern. In other embodiments, thermally induced swelling contributes to the desired B-stage increase in viscosity upon mild heating. The B-staged composition preferably also is somewhat tacky, allowing a substrate to adhere to an adherent long enough for the subsequent thermal cure reaction to effectively complete.

In some embodiments, the composition of the present disclosure comprises a liquid epoxy resin containing polymerizable epoxide groups, a polymer particle with acid functionality on the surface of the particle, an effective amount of a thermally activated epoxy cure agent or an effective amount of a thermally activated epoxy cure catalyst.

With respect to the epoxy resin used in the present invention disclosure, there is no particular limitation as long as it cures to exhibit an adhesive action and is compatible with the intended use, for example, electronic assembly. An epoxy resin having two or more functional groups and preferably having a molecular weight of less than 5,000, more preferably less than 3,000 can be used. For example, bifunctional epoxy resins, such as a bisphenol A epoxy resin and a bisphenol F epoxy resin, and novolak epoxy resins, such as a phenolic novolak epoxy resin and a cresol novolak epoxy resin, or amine epoxy resins, can be used. In addition, generally known polyfunctional epoxy resins, heterocycle-containing epoxy resins, and alicyclic epoxy resins can be used. These epoxy resins may be used alone or in combinations of two or more chemical types or molecular weight ranges.

In some embodiments of the present invention disclosure, examples of curing agents for epoxy resins include, but are not limited to, acid anhydrides, amine compounds, and phenolic compounds. Examples of suitable curing catalysts for epoxy resins include imidazoles and derivatives thereof, tertiary amines, and quaternary ammonium salts.

A presently preferred embodiment of the compositions of the present invention disclosure comprises at least one epoxy resin, an anhydride curing agent, an optional imidazole-based catalyst, interactive polymeric particles and other ingredients as desired. In some embodiments, the composition will comprise at least about 30 wt %, preferably at least about 50 weight percent (wt %) of epoxy resin. In other embodiments, the composition will comprise no more than about 98 wt % of epoxy resin, preferably below about 90 wt %. In some embodiments, the composition will also comprise at least about 2 wt %, preferably at least about 30 wt % of an anhydride curing agent. In other embodiments, the composition will comprise no more than about 70 wt % of an anhydride curing agent and preferably below about 50 wt % of the composition. In those embodiments in which a catalyst is used, the catalyst comprises at least about 0.01 wt %, preferably at least about 0.1 wt % of the composition. In other embodiments, the catalyst comprises no more than about 5 wt % of the composition, preferably no more than about 10 wt %. The interactive polymeric particles, described in greater detail below, comprise from about 15 wt % to about 35 wt % of the composition. One skilled in this art will appreciate that the exact proportions of the various components should reflect the molecular weights and functionality of the various mutually reactive components as well as the mechanical properties desired in the bond. The composition may also include optional fillers, viscosity modifiers, colorants, and conductive particles in such amounts as desirable for the intended application.

The curing agent for the epoxy resin may be selected from many various curing agents which are well known for epoxy resins in the art. Curatives for the epoxy can include phenolic resins containing at least two phenolic hydroxyl groups per molecule, such as bisphenol A, trimethylol allyloxyphenol, phenol novolac resins having a low degree of polymerization, epoxidized or butylated phenolic resins, and phenolic resins available under the trade name of Super Beckacite 1001 (Japan Rechhold Chemical Co., Ltd.), Hitanol 4010 (Hitachi Ltd.), Scado form L-9 (Scado Zwoll, Netherlands), and Methylon 75108 (General Electric Co.); resins available as Beckamine P-138 (Japan Rechhold Chemical Co., Ltd.), Melan (Hitachi Ltd.) and U-Van 10R (Toyo Koatsu Kogyo Co., Ltd.); and organic acids and acid anhydrides such as phthalic anhydride, hexahydrophthalic anhydride, tetrahydrophthalic anhydride, pyromellitic anhydride, methylnadic acid, dodecylsuccinic anhydride, and chlorendic anhydride. Of the foregoing curing agents, phenolic resins (specifically phenol novolac resins) are desirable in imparting ease of molding and humidity resistance to the inventive composition and because of non-toxicity and relatively low cost. The curing agent used herein is not limited to a single type and mixtures of two or more types may be used depending on their curing ability.

The curing agent may be used in any desired amount depending on a particular type, and usually in an amount of at least about 1 parts by weight of the epoxy resin (pbw), more preferably at least about 5 pbw. In other embodiments, the curing agent is provided in amounts no more than about 100 pbw, more preferably below about 50 pbw. Less than 1 part of the curing agent can be difficult for causing the inventive composition to cure whereas more than 100 parts of the curing agent can be uneconomical, require a longer time for curing because the epoxy resin is diluted therewith, and/or result in cured products with poor physical properties.

In some embodiments, imidazoles, imidazole salts, derivatives, and combinations thereof may be added as a catalyst. Latent catalysts useful in one part epoxy adhesives are preferred catalysts. Illustrative catalysts include blocked imidazoles MZ-A, MA-OK and PHZ-S (Air Products) and polymer bound imidazoles such as Intelimer 7004 (Landec Inc.). The catalyst, if present in an embodiment, comprises at least about 0.01 wt %, preferably at least about 0.1 wt % of the composition. In other embodiments, the catalyst comprises no more than about 5 wt % of the composition, preferably no more than about 10 wt %.

In some embodiments, the polymer particles having acid functionality on the surface of the particles, which particles in some embodiments have mean diameters of less than 100 micron, preferably less than 100 micron, more preferably less than 10 micron. Preferably in some embodiments, the particles have mean diameters larger than 0.1 micron, more preferably larger than 0.5 micron. Spherical particles with an average size of less than 0.1 micron may result in a composition which does not flow smoothly whereas particulates with an average particle size of more than 100 microns may adversely affect the moldability and other characteristics of the adhesive system. In some embodiments, the particles may be homogenous while in other embodiments they may be of a core-shell morphology or even have a surface partially covered with available acid groups. Although acid groups on the surface of the polymer particle are typically more readily available for reaction with the epoxy resin, in some embodiments, acid or acid anhydride groups which are initially below the surface of the particle may become available for reaction with the epoxy groups of the epoxy resin upon mild heating. For the purpose of this application acid or acid anhydride groups which become available at the surface of the particles may be considered to be available at the surface of the particles.

Throughout this application unless otherwise specified, mild heating will refer to heating the composition to a first temperature which is sufficient to initiate a chemical reaction between the epoxy resin and the acid or acid anhydride groups associated with the particle surfaces, to swell the particles in the presence of the epoxy resin, or to effect a combination of reaction and swelling sufficient to increase the viscosity of the composition to a desirable level for the B-stage. In some embodiments, the first temperature will be selected to be high enough to prevent premature viscosity increases prior to application to a substrate. In some embodiments, it may be desirable to store the adhesive composition at or below about 20° C. In other embodiments it would be protect the adhesive composition from exposure to temperatures above about 80° C. prior to application to the substrate. The first temperature will be lower than a second, higher temperature which is necessary to significantly initiate a reaction between the epoxy resin and the curing agent or to thermally activate an imidazole or other catalyst, or a combination thereof. In some embodiments, the temperature at which the adhesive composition is B-staged will be greater than about 90° C. In other embodiments, the temperature at which the adhesive composition is B-staged will be less than about 120° C. It will be appreciated by those of skill in the art that the specific temperatures associated with the terms “first temperature” and “second, higher temperature” will, of necessity, depend upon the chemical components of a specific embodiment of the compositions of the invention and the properties of the materials to be bonded or adhered by the composition, the difference between the first, lower temperature and the second, higher temperature will generally be such that exposure to the first temperature is sufficient to produce the B-stage adhesive without significant advancement of the final cure mechanism or mechanisms. In some embodiments, the difference between the first temperature and the second, higher temperature will be at least about 25° C., preferably at least about 30° C. In other embodiments, the difference between the first temperature and the second, higher temperature will be no more than about 50° C., preferably no more than about 40° C. If the difference between the first, lower temperature and the second, higher temperature is too small, it may be difficult to limit the onset of the higher temperature cure reaction or reactions. If the difference between the first, lower temperature and the second, higher temperature is too large, the energy demands of the overall process may be undesirably high and damage to one or both of the materials to be joined may result. In some embodiments, the second, higher temperature will be greater than about 115° C., preferably greater than about 130° C. In other embodiments, the second, higher temperature will be no greater than about 150° C., preferably no greater than about 140° C.

In some preferred embodiments, the final thermal cure mechanism is a relatively slow reaction at the first temperature compared to the B-staging reaction that initially increases the viscosity of the resin. The relatively slower kinetics of this mechanism allow the same generic triggering event, heating, to initiate both reactions so that the adhesive composition is B-staged and tacky almost immediately after initial heating to a first temperature, but which does not fully cure until a later time at a second, higher temperature, allowing time for the substrate and adherent to be properly aligned before curing is complete. In some embodiments, the B-staged composition preferably is tacky enough to hold the substrate and adherent in place during the thermal cure without requiring known additional clamping means. In some embodiments, a final thermal cure at a second, higher temperature takes at least about 0.1 hours, preferably at least about 0.25 hour. In other embodiments, the final thermal cure requires no more than about 0.75 hours at the second, higher temperature, preferably no more than about 1.5 hours, to complete, allowing adequate time after initial heating to ensure that there is adequate contact between the adhesive composition, the substrate, and the adherent. In some embodiments, longer final thermal cure times at lower second, higher temperatures may be acceptable or even desirable.

In some embodiments, the acid or acid anhydride functionality associated with the polymer particles is less than the available epoxy functionality of the epoxy resin. In those embodiments, it is preferable that the ratio of epoxy groups to acid groups be at least 10:1, more preferably at least 25:1, and most preferably at least 50:1. If the available acid functionality is too high, the resin system may cure prematurely. If it is too low, the resin may not achieve sufficient viscosity in the B-stage to minimize slumping under the desired application conditions. In some embodiments, the acid functionality may be provided as the acid anhydride. In those embodiments, the anhydride groups should provide equivalent acid groups in approximately the ratios indicated above.

In some embodiments, it is believed that simple swelling of the polymeric particles by the epoxy resin at mildly elevated temperatures contributes to the viscosity increase normally attained by chemical B-staging of the resin and may be sufficient to replace chemical reaction as the viscosity increasing mechanism. In embodiments where swelling is desirable or important, the rate and degree of swelling of the polymeric particles are thought to be related to the degree of match or mismatch between the solubility parameter of the particles and the other components of the formulation as a function of temperature. In some embodiments, particles having a glass transition temperature in the range of the B-stage heating step may be desirable. In some embodiments, the rate of viscosity increase due to swelling of the particles during the B-stage heating step may be greater than the rate of viscosity increase due to chemical reaction at the same temperature. As in the case of the acid functional particles, swellable particles may be homogenous or may have a core-shell morphology. In these swellable embodiments, acid or anhydride groups need not be present if swelling alone is sufficient to increase viscosity to a useful level. In other embodiments, a combination of reactive functional groups on the particle and thermally induced swelling may be used. Accordingly, for the purposes of this application, the term “B-stage reaction” or simply “B-stage” includes viscosity increases which result from heating at temperatures below the final cure temperature. In some embodiments, such viscosity increases upon brief heating are substantially irreversible.

Upon initial heating to a first temperature, a reaction between the epoxy groups of the resin and the acid groups on the surface of the particles and/or swelling of the particles causes the adhesive composition to increase in viscosity. The increase in viscosity should be such that the adhesive compound remains essentially within the predetermined printed pattern, minimizing slumping. In some embodiments, the viscosity increase upon heating to a first, lower temperature is at least one order of magnitude, and preferably at least two orders of magnitude, higher than the viscosity at the application temperature. It is also preferred in some embodiments that the viscosity increase be self-limiting at the first temperature. That is, continued heating at the lower temperature does not greatly increase the viscosity of the composition beyond the B-stage thus showing a plateau in a plot of viscosity vs. time at the first temperature which is more than one order of magnitude below the viscosity attained when the second, higher temperature cure is activated. Without being bound by theory, it is believed that the limited amount of available acid and/or anhydride functionality and/or the limited swellable volume provided by the plurality of particles provides the self-limiting viscosity increase at a temperature below that at which the final cure of the epoxy resin system occurs.

In one embodiment, the adhesive composition includes a thixotropic filler to prevent the adhesive composition from slumping beyond the predetermined application footprint before the composition can be B-staged and finally cured. The initial application footprint may be referred to as a decal in some assembly operations. In some embodiments, it is desirable that such a decal substantially retain the size and shape which it has, as initially deposited, throughout an assembly operation. An example of a thixotropic agent useful in the adhesive composition of the present invention is a silicone-treated silica, such as AEROSIL R202 available from Degussa Corp. (Parsippany, N.J.). In one embodiment, the weight percentage of the thixotropic agent in the adhesive composition is at least about 1%, and preferably at least about 5%. In another embodiment, the weight percentage of the thixotropic agent is no more than about 15%, preferably no more than about 10%.

For some applications, it may be desirable to include a pathway for electrical conduction between the adherent and the substrate. In some embodiments, the conductive particles are employed for their thermal conductivity. In some embodiments, conductive particles may be used to provide both electrical and thermal conductivity. Therefore, in some embodiments, conductive particles are blended into the composition before printing. In one embodiment, if the conductive particles are present, then the weight percentage of the conductive particles within the adhesive composition is at least about 1%, preferably at least about 5%. In another embodiment, the weight percentage of the conductive particles in the adhesive composition, if present, is not more than about 20%, preferably no more than about 10%. Examples of conductive particles which may be used in the adhesive composition include silver-covered glass particles such as Ag/glass 43 micrometers by Potters Industries Inc. (Valley Forge, Pa.).

The conductive particles used may be commonly employed conductive particles such as carbon particles or metal particles of silver, copper, nickel, gold, tin, zinc, platinum, palladium, iron, tungsten, molybdenum, solder or the like. In some embodiments, it is possible to use non-conductive particles of a polymer such as polyethylene, polystyrene, phenol resin, epoxide resin, acryl resin or benzoguanamine resin, or glass beads, silica, graphite or a ceramic, whose surfaces have been covered, at least partially, with a conductive coating of a metal or the like or which contain dispersed within them conductive materials.

The electrically conductive particles are available in a variety of shapes (spherical, ellipsoidal, cylindrical, flakes, needle, whisker, platelet, agglomerate, crystal, acicular). The particle may have a slightly rough or spiked surface. The shape of the electrically conductive particles is not particularly limited. Combinations of particle shapes, sizes, and hardness may be used in the compositions of the invention. In some embodiments, the conductive particles may have an average diameter greater than about 4 micron, preferably greater than about 10 micron. In other embodiments, the conductive particles may have an average diameter no greater than about 30 micron, preferably no greater than 15 micron. Any of several particle types and combinations thereof may be selected based on the end use application. Factors such as metallurgy and the hardness of the substrate and adherent may be use to select the particle type or types for a given application.

A method of adhering a substrate to an adherent in an electrical component is also provided which includes providing an adhesive composition comprising an epoxy resin that is curable with a plurality of polymer particles preferably having acid functionality on the surface of the particle, a thermally activated cure agent or a thermally activated cure catalyst, and an epoxy cure agent or an epoxy cure catalyst; providing a substrate; providing an adherent; applying the adhesive composition onto the substrate, such as by printing; initially heating the adhesive composition to achieve an increase in viscosity; applying the adherent to the resulting adhesive composition; and allowing the epoxy resin to thermally cure at a higher temperature so that the substrate is adhered to the adherent. In some embodiments, the B-staged adhesive is allowed to cool before applying the adherent to the resulting adhesive composition while in other embodiments the heating process is paused or even continued throughout the heating process. In some embodiments in which the intermediate cooling step is omitted, it has been found that the differential rates of a faster, lower temperature B-stage cure process and a slower, final high temperature cure process may be selected such that a significant window exists during which the assembly operations may be carried out. If conductive particles are present, an electrical and/or thermal connection between the substrate and the adherent is established after initial heating of the adhesive composition and applying the adherent to the adhesive composition. The adherent is rapidly pressed against the substrate, providing a conductive path between contacting pads via the conductive particles.

The electronic assembly of the present invention can be made by any known method, such as the method disclosed in US 2005/0282355 Edwards et al., US 2005/0270757, and U.S. Pat. No. 6,940,408 Ferguson et al., the disclosures of which are herein incorporated by reference. However, the composition of the present invention can be printed, B-staged to prevent undesirable slumping, to provide sufficient green strength, and to retain placement during a subsequent thermal cure.

Finally, optional ingredients such as surfactants, air release agents, flow additives, rheology modifiers, and adhesion promoters may be added to the composition in the range of about 0.01 wt % to about 5 wt % of the composition.

One application of the adhesive of the invention is in the assembly and protection of semiconductor devices. Integrated circuits are encapsulated within packages to protect the die and electrical interconnections thereto from the outside environment. One method of packaging an integrated circuit generally includes the processes of bonding the die to a paddle or pad of a lead frame. One configuration of such a package is often referred to as a micro leaded package. After the die is bonded to the lead frame, the bond pads on the die are wire bonded to the inner leads or lead fingers of the lead frame, and the die, inner leads, and bond wires are encapsulated in an encapsulant material. The process of bonding the die to the paddle of the lead frame is typically accomplished by placing the die onto a layer of die attach material, such as, for example, an adhesive of the invention, that has been previously placed onto the paddle. The die attach material may be thermally conductive to thereby enable and/or enhance heat dissipation, and may or may not be electrically conductive.

In some applications, the adhesive composition may be applied to a temporary substrate having a degree of adhesive release character, be B-staged by exposure to a first temperature, transferred to a first substrate to be joined, applied to a second substrate to be joined, and heated to a second, higher temperature to complete the cure of the adhesive composition.

In some embodiments, the adhesive composition may further comprise conductive particles. The conductive particles, if present, may be electrically conductive, thermally conductive or both electrically and thermally conductive. The conductive particles may comprise a mixture of conductive different particles having different compositions.

In some embodiments, the adhesive composition comprises a plurality of polymeric particles having acid or acid anhydride functionality on their surfaces. In some embodiments, the acid or acid anhydride functionality on the surface of the polymeric particles provides fewer acid equivalents than the epoxy equivalents provided by the curable epoxy resin. In some embodiments, the plurality of polymeric particles has a mean particle diameter between about 0.1 micron and about 100 microns. In some embodiments, the plurality of polymeric particles has a surface which may be swollen by exposure to the epoxy resin at a first, lower temperature. In some embodiments, the polymeric particles may have acid or acid anhydride functionality on their surface in addition to being swellable upon exposure to the epoxy resin at a first temperature. In further embodiments, the plurality of polymeric particles may include particles having acid or acid anhydride functionality on their surfaces and particles swellable upon exposure to the epoxy resin at a first temperature.

In some embodiments, the curing agent of the adhesive composition is selected from acid anhydrides, amine compounds, and phenolic compounds. In some embodiments, the curing catalyst of the adhesive composition is selected from imidazoles, imidazole salts, and derivatives thereof, tertiary amines, and quaternary ammonium salts.

In some embodiments, the adhesive comprises a thermal reaction product of the adhesive composition formed by heating the adhesive composition to at least a first temperature. In further embodiments, the adhesive composition comprising the thermal reaction product also comprises conductive particles. In some embodiments, the thermal reaction product formed by heating the adhesive composition to a first temperature is capable of further thermal reaction upon heating to the second, higher temperature. In some embodiments, the invention provides an assembly in which a first and a second substrate are joined by an adhesive composition comprising a thermal reaction product formed by heating the adhesive composition to a first temperature. In further embodiments, the adhesive composition which has been heated to a first temperature and used to join two substrates is heated to a second, higher temperature to further advance the cure of the adhesive composition. In some embodiments, the adhesive composition is allowed to cool after exposure to a first temperature before heating to a second, higher temperature to complete the cure. In other embodiments, the adhesive composition is applied to a first substrate, heated to a first, lower temperature, held at that temperature for a time sufficient to increase the viscosity of the composition through a reaction between the curable epoxy resin and the plurality of acid or acid anhydride surface functional groups or by swelling the polymeric particles in the presence of the curable epoxy resin, applying the other adherent or substrate, and heating the assembly to a second, higher temperature. In some embodiments, the first and second substrates are electronic circuits and the adhesive contains conductive particles, wherein the adhesive electrically interconnects the circuits. In some embodiments, the substrate is a component of a semiconductor package.

In some embodiments, the invention provides a method of preparing an adhesive composition for electronic assembly comprising combining a curable epoxy resin, a plurality of polymeric particles having at least one of a plurality of acid or acid anhydride functional groups on its surface, or a surface which swells in the presence of the curable epoxy resin, upon heating to a first temperature, and at least one of a thermally activated cure agent for curable epoxy resins or a thermally activated cure catalyst for curable epoxy resins which becomes active at a second, higher temperature. In some further embodiments, the adhesive composition may optionally include conductive particles. In other embodiments, the adhesive composition may be prepared by combining the ingredients and heating to a first temperature sufficient to increase the viscosity of the composition through a reaction between the curable epoxy resin and the plurality of acid or acid anhydride surface functional groups or by swelling the polymeric particles in the presence of the curable epoxy resin. In further embodiments, the composition is heated to a second, higher temperature to further cure the composition.

Objects and advantages of this invention are further illustrated by the following non-limiting examples, but the particular materials and amounts thereof recited in these examples, as well as other conditions and details, should not be construed to unduly limit this invention.

### EXAMPLES

### Example 1

An adhesive composition (in parts by weight) was prepared by mixing 27.5 parts EPON 828 (Resolution Performance Products LLC, Houston, Tex.); 27.5 parts EPON 862 (Resolution Performance Products LLC); 13.7 parts Helox 107 (Hexion Specialty Chemicals, Inc., Houston, Tex.); each of these epoxy resins having been purified by the method of US2002/0022709, in a high shear mixer for one minute with 23.0 parts core/shell particles having a core of cross linked acrylic rubber and a shell of acid functional polymethylmethacrylate copolymer obtained from Nippon Zeon Co., Tokyo, JP, under the trade designation F351; 1.7 parts Raven 7000 carbon black (Columbian Chemicals, Marietta, Ga.); 2.3 parts Aerosil R202 thixotropic agent (Degusa Corp., Piscataway, N.J.); and 4.3 parts 1-cyanoethyl-2-ethyl-4-methylimidazole (obtained as Curez 2E4MZ-CN from Shikoku International, Los Angeles, Calif.). The resulting adhesive was stencil printed in a 6 mm×6 mm grid pattern onto aluminum panels to form adhesive decals. The samples were B-staged by placing on a hot plate and exposing the adhesive to a temperature of 85° C. for 1 minute. The resulting B-stage adhesive was used to adhere the aluminum panels to glass slides which were placed on the adhesive and seated with slight pressure to achieve good wetting. The sample was then placed in an oven at 125° C. for one hour to cure the adhesive. The adhesive decals maintained sharp images.

### Comparative Example A

An aluminum panel bearing printed decals prepared as described in Example 1 was used to adhere a glass slide without first B-staging the resin. Pressure could not be used without undesirably deforming the resin decal. The sample was cured at 125° C. for one hour to cure the adhesive as before. Comparative Example A exhibited high flow and undesirable deformation of the decal due to the weight of the glass slide and lowering of the viscosity before the adhesive could B-stage.

Both Example 1 and Comparative Example A showed very good adhesion after thermal cure. The glass could not be removed from the aluminum panel of Example 1 or Comparative Example A without breaking the glass.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

What is claimed is:

1. An adhesive composition for electronic assembly comprising:
a curable epoxy resin;
a plurality of polymeric particles having at least one of
a plurality of acid or acid anhydride functional groups on its surface, or
a surface which swells in the presence of the curable epoxy resin at or above a first temperature;
and at least one of a thermally activated cure agent for curable epoxy resins or a thermally activated cure catalyst for curable epoxy resins which becomes active at a second temperature, wherein the second temperature is higher than the first temperature.

2. An adhesive composition according to claim 1 further comprising conductive particles.

3. An adhesive composition according to claim 1, wherein said plurality of polymeric particles have acid or acid anhydride functionality on the surface of the particles.

4. An adhesive composition of claim 3 wherein the acid or acid anhydride functionality on the surface of the polymeric particles provides fewer acid equivalents than the epoxy equivalents provided by the curable epoxy resin.

5. An adhesive composition of claim 1 wherein the plurality of polymeric particles has a mean particle diameter between about 0.1 micron and about 100 microns.

6. An adhesive composition according to claim 1, wherein said curing agent is selected from acid anhydrides, amine compounds, and phenolic compounds.

7. An adhesive composition according to claim 1, wherein said curing catalyst is selected from imidazoles, imidazole salts, and derivatives thereof, tertiary amines, and quaternary ammonium salts.

8. An adhesive composition for electronic assembly comprising:
a thermal reaction product of the composition of claim 1 formed by heating the composition to at least a first temperature.

9. The adhesive composition of claim 8 wherein the thermal reaction product of the composition of claim 1 is capable of further thermal reaction upon heating to a second temperature, wherein the second temperature is higher than the first temperature.

10. The adhesive composition of claim 8 further comprising conductive particles.

11. An assembly comprising:
a first substrate, which may comprise an electronic circuit or device;
a second substrate, which may comprise an electronic circuit or device; and
the adhesive of claim 1 adhering the first and second substrates;
optionally wherein, when the first and second substrates are electronic circuits and the adhesive contains conductive particles, the adhesive electrically interconnects the circuits.

12. An assembly comprising:
a first substrate, which may comprise an electronic circuit or device;
a second substrate, which may comprise an electronic circuit or device; and
the adhesive of claim 8 adhering the first and second substrates;
optionally wherein, when the first and second substrates are electronic circuits and the adhesive contains conductive particles, the adhesive electrically interconnects the circuits.

13. A method for assembly comprising:
providing the adhesive composition of claim 1;
providing a substrate and an adherent;
applying said adhesive composition to one of said substrate and said adherent;
heating said applied adhesive composition to a first temperature; cooling said adhesive composition; applying the other of said substrate and said adherent to said heated adhesive composition; and
heating said adhesive composition to a second temperature to further advance the cure of the adhesive composition, wherein the second temperature is higher than the first temperature.

14. A method according to claim 13, wherein said substrate is a component of a semiconductor package.

15. A method for assembly comprising:
providing the adhesive composition of claim 8;
providing a substrate and an adherent;
applying said adhesive composition to one of said substrate and said adherent;
applying the other of said substrate and said adherent to said heated adhesive composition; and
heating said adhesive composition to a second temperature to further advance the cure of the adhesive composition, wherein the second temperature is higher than the first temperature of claim 8.

16. A method for assembly comprising:
providing the adhesive composition of claim 1;
providing a substrate and an adherent;
applying said adhesive composition to one of said substrate and said adherent;
heating said applied adhesive composition to a first temperature;
applying the other of said substrate and said adherent to said heated adhesive composition;
and continuing heating of said adhesive composition to a second temperature, higher than the first temperature to further advance the cure of the adhesive composition.

17. A method according to claim 16, wherein said substrate is component of a semiconductor package.

18. A method for assembly comprising:
providing the adhesive composition of claim 8;
providing a substrate and an adherent;
applying said adhesive composition to one of said substrate and said adherent;
heating said applied adhesive composition to a first temperature;
applying the other of said substrate and said adherent to said heated adhesive composition;
and continuing heating of said adhesive composition to a second temperature, higher than the first temperature, to further advance the cure of the adhesive composition.

19. A method of preparing an adhesive composition comprising:
combining a curable epoxy resin;
a plurality of polymeric particles having at least one of
a plurality of acid or acid anhydride functional groups on its surface, or
a surface which swells in the presence of the curable epoxy resin at or above a first temperature;
and at least one of a thermally activated cure agent for curable epoxy resins or a thermally activated cure catalyst for curable epoxy resins which becomes active at a second temperature, wherein the second temperature is higher than the first temperature.

20. A method of preparing an adhesive composition comprising:
combining a curable epoxy resin;
a plurality of polymeric particles having at least one of
a plurality of acid or acid anhydride functional groups on its surface, or
a surface which swells in the presence of the curable epoxy resin at or above a first temperature;
and at least one of a thermally activated cure agent for curable epoxy resins or a thermally activated cure catalyst for curable epoxy resins which becomes active at a second temperature, wherein the second temperature is higher than the first temperature, and
optionally conductive particles, to form a composition;
heating the composition to a first temperature sufficient to increase the viscosity of the composition through a reaction between the curable epoxy resin and the plurality of acid or acid anhydride surface functional groups or by swelling the polymeric particles in the presence of the curable epoxy resin;
and heating said adhesive composition to a higher temperature to further advance the cure of the adhesive composition.
